(19) United States
(12) Patent Application Publication
(10) Pub. No.: US 2008/0144072 A1
(43) Pub. Date: Jun. 19, 2008

(54) Validation system and method therefor

(75) Inventors: Anthony Levan, Eltham Victoria (AU); Jason Dabbs, Eltham Victoria (AU)

Correspondence Address: TRASK BRITT, P.O. BOX 2550, SALT LAKE CITY, UT, 84110, US

(73) Assignee: iRegistry Pty ltd., Melbourne Victoria (AU)

(21) Appl. No.: 11/473,480

(22) Filed: Jun. 23, 2006

(51) Int. Cl. G06F 3/12

(52) U.S. Cl. 358/1.15

(57) ABSTRACT

A system to record the status of an item comprising: a registry to store information in a register, the information including unique identifying means and unique owner identification means for the item; communication means such as a telephone network link to establish a communication link between the registry and electronic communication means uniquely associated with the owner; processing means to receive the unique identification means via the communication link and to link it to the record of the item in the register; transmission means that is linked to the communication means to transmit an activation means to the electronic communication means to invite a user to reply to the transmission of the activation means back to the registry; and activation means that changes the status of the record and to activate the record on the register on receipt of the returned activation means from the electronic communication means.

### BACKGROUND OF THE INVENTION

1. Field of the Invention

This invention relates to a validation system and method therefor. More particularly, this invention relates to a validation system and method therefor utilizing an identification and status register for the registration of items for which there is typically no statutory registration system.

2. State of the Art

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

A large proportion of valuable items do not enjoy protection from theft by virtue of a statutory registration system. Items such as bicycles, off road motorcycles, white goods, electronic devices such as televisions, VCRs, CDs/DVD players/recorders, computers, manufacturing equipment, office equipment, trade equipment, art work, including sculptures, paintings and the like, are not generally registrable under any statutory regime. A particular example of the need for a non-statutory registration system is the off road motorcycle.

The ease with which off road motorcycles can be stolen and the lack of adequate mechanisms for identifying stolen off road motorcycles and their parts render off road motorcycles particularly susceptible to professional and/or opportunistic thieves who seek to convert a stolen off road motorcycle into cash.

Whilst off road motorcycle theft accounts for a smaller percentage of the nation's reported vehicle thefts, they are much less likely to be recovered and more likely to be stolen as part of a multiple theft incident.

The dynamics of off road motorcycle theft are quite distinct from the theft of other statutory registrable vehicles. 10,160 motorcycles were reported stolen in Australia during 2003. Fewer than 30% of stolen motorcycles were recovered. While registered bikes accounted for less then half of reported motorcycles thefts, they recorded a substantially higher recovery rate (36%) than unregistered bikes (19%).

Late model motorcycles are typically more likely to be stolen than their older counterparts and motorcycles manufactured by premium manufacturers account for over half of reported thefts in Australia. Over 10% of reported motorcycles thefts were as a result of a multiple theft incident where more than one motorcycle was stolen at the same time. The motorcycles most vulnerable to theft are unregistered off-road bikes and generally it is the experience of many bike owners of stolen bikes that they are powerless to prevent the bike's on-sale. Although, in Australia, relevant Government authorities and representative motorcycle organizations have recognized the need for a registration system for off-road motorcycles, to date such plans have been shelved due mainly to the cost of implementation.

An analysis of the new motorcycle market in Australia shows that new bike sales in 2004 comprised the following breakdown:
Road (36%), ATV (16%) and off-road (48%)

This breakdown indicates that the two sections of the new bike sales industry that cater for unregistered bikes constitute 64% of the market (the combination of ATV and off-road bikes). In 2004 in Australia there were a total of 89,374 bikes sold of which 57,199 where off-road. The used unregistered motorcycle is even larger.

A bike owner of a non-registered motorcycle typically does not have access to a registration system to protect their property from being sold if stolen and an unwitting private purchaser or motorcycle dealer has little opportunity to check whether a motorcycle they propose to acquire is sourced from a genuine owner. In particular, there are many situations where a motorcycle has been stolen from one state or territory and shortly thereafter sold to a dealer in a different state. The dealer may be genuine and may have done every check possible through statutory and other available systems, but due to the fact that a central registry for dirt bikes or other non-registered vehicles does not exist, they still run the risk that they are dealing in stolen property. For a dealer there is more to lose than just money—their trading licence may be revoked.

Similarly, for a private buyer about to purchase an off-road bike there is no way of knowing the stolen status of a motorcycle.

Typically, a purchaser of an unregistered item must accept the risk that the item that they are purchasing is stolen. Interested industry organizations such as insurance companies (especially those that insure off-road bikes) do not enjoy success in recovering vehicles that have been stolen and for which they have paid out claims (there is generally a 1% recovery rate). However, to date the inventors are unaware of any viable commercial registry that has been implemented and that has an adequate security protocol to protect the integrity of the registry against fraudulent abuse.

A significant barrier to the implementation of such a registry system is the need to have sufficient security procedures in place to ensure that such a registry is not hijacked and fraudulently abused by the criminal elements such a registry is intended to thwart. Moreover, to promote participation by the majority of off-road motorcycle owners, it is desirable to have a payment method attracting minimal costs.

Accordingly there is a need for a system and/or method that ameliorates the abovementioned problems or at least provides a useful alternative to current procedures and systems in place.

### BRIEF SUMMARY OF THE INVENTION

In accordance with one aspect of the invention there is provided a method for recording the status of an item by a user, the item not subject to statutory registration, the method including the steps of:

(A) the user sending information to a registry having a register, the information including:
(a) optionally, information to uniquely identify the owner of the item;
(b) information to uniquely identify the item; and
(c) access details of a communication means traceable to the owner and having a communication protocol compatible with the registry;

(B) creating a record of the item on the register;

(C) the registry sending a means to activate the record to the communication means using the access details;

(D) the user sending the activation means to the registry using the communication means or another compatible communication means; and

(F) on receipt of the activation means, the registry activating the record.

Preferably step (F) includes the further step of attributing a status to the record.

A system implementing the above method is also contemplated within the scope of the present invention.

In another aspect of the invention, there is provided a method for recording the ownership of an item by an owner, the item having associated therewith a unique identification means, the method including the steps of:
providing a registry to store data and/or information in a register including the unique identification means and unique owner identification means;
establishing communication link between the register and an electronic communication means that is or can be uniquely associated with the owner;
receiving information enabling the characterization or description of the item in the register;
recording the unique identification means linked to the record of the item in the register;
transmitting an activation means to the electronic communication means inviting user to reply by transmitting the activation means back to the registry; and
activating the record of the item on the register on receipt of returned activation means from the electronic means.

A system implementing the above method is also contemplated as being within the scope of the present invention.

The item may be any object, particularly an object of value, not typically made the subject of a statutory registration system. For example, the item may be a bicycle, motorcycle, white good, electronic device such as a television, VCR, CD/DVD player/recorder, computer, a piece of manufacturing, office or trade equipment, art work such as sculptures or paintings, jewelry, rare books and so on.

The item, however, is preferably somehow identifiable with reference to a unique identification means that is able to be adequately documented on a record on the register. The unique identification means may include an alpha numeric code, an identifying signal or mark, a badge or origin able to be identified and characterized so as to be retrievable, a unique description such as for a work of art whereby to identify the item to the exclusion of all other items of like kind. Preferably, the item will bear a unique identification code. In the case of motorcycles, the unique identification means may be a vehicle identification number (VIN), chassis number or engine number. However, in the case of works of art, a characterizing description optionally supplemented by reference to the author's or creator's signature, or a facsimile thereof, may be adequate to uniquely identify the item.

The owner may be a legal person such as an individual or company or may be a group of individuals such as a partnership. In any case, the owner is a reference to the legal owner of the item. In the case of a company, business or partnership, the owner may be represented by a user such as an employee who is authorized to enter such records on the register on behalf of the owner.

The register includes any systemized information storage and retrievable system. The register may be a database, typically computer based, and is preferably relational to optimize storage capacity and to better organize stored data and information. The registry includes the register and the infrastructure and computing processes that may be required to operate the register. The registry may be implemented in a computer system having computer processing capabilities and may include a combination of hardware and software. Multiple registers and/or registries may be provided to provide a registration service according to the invention in respect of different types of items. For example, a registry may provide a plurality of registers, one register for motorcycles, another for bicycles and another for domestic electronic goods.

The registry may be accessible to members of the public or access may be limited to a particular group. For example, the registry may be available only to subscribers or fee for service customers or may be accessible only on an intranet or local area network whereby accessibility is limited. Preferably, however, the registry is accessible on the internet or another global information or communication network and is accessible to members of the public, albeit on a fee for service basis.

The owner identification means may simply include name and address details of the owner, but may also include unique identifying codes or numbers, such as a license, tax file or social security number. Preferably the owner identification means includes the customary name and address details, preferably including telephone, fax and/or email details.

The communication means includes any suitable communication means, most typically electronic communication means. The communication means may include a Personal Digital Accessory (PDA) or other computing device such as a lap top or notebook, provided that such communication means is equipped with a personal identification means whereby the ownership of the communication means is traceable to the owner. For example, the communication means may be provided with an iris, hand or finger scanning means whereby to enable the owner to be uniquely identified. Most preferably, the communication means is a telephone device and still more preferably the communication means is a mobile telephone. Preferably, the communication means is capable of sending and receiving text based messages and advantageously this may be achieved using short message service (SMS) technologies.

By corollary, the communication link that may be established between the registry and the communication means may include a landline, such as an internet or telephone connection as well as a wireless communication link, such as by radio signals, and may include mobile phone technology.

The access details of the communication means may be the access code by which the communication means can be engaged. Preferably, the access details comprise a character string and, still more preferably, a number.

The information uniquely identifying the item may include a written description with controlled vocabulary key words, and/or the color, make, model, engine number, vehicle identification number, chassis number and so on. To facilitate retrieval of relevant records in the register by the searcher, the categorizing system may include a subject based system such as a classification or indexing system. Alternatively, items may be arranged alphabetically or by other criteria such as material industry field, including categories such as transport, sport, office equipment, domestic appliances and so on. Examples of such categorized items may be found on commercial websites such as those belonging to eBay™ and The Trading Post™.

The activation means may include an activation signal or code that is preferably secure and is preferably digital, although an analogue signal is within the scope of the invention. Accordingly, the activation means includes an alpha numeric code and/or an electronic signal able to be received and transmitted by the communication means. The activation means may be a coded electronic signal. The activation means such as a signal, code or character string may be encoded or encrypted. Most preferably, the activation means is an alphabetical, numeric or alpha numeric code susceptible to input by a user using a keyboard, keypad or other data input device including an input device with a verbal recognition capability.

In a particularly preferred form of the invention, the item is a motorcycle and the registry is for the purpose of providing a register for statutorily unregisterable motorcycles. Accordingly, in another aspect of the invention there is provided a method for recording the ownership of a motorcycle by the owner of the motorcycle or a person on the owner's behalf, the method including the steps of:
(a) the owner sending information to a registry having a register, the information including:
   (i) optionally, information to identify the owner or to access an entry of the owner on the register;
   (ii) information to uniquely identify the motorcycle to create a record of the motorcycle on the register; and
   (iii) telephone number of a mobile telephone traceable to the owner and having a Short Message Service capability compatible with communication protocols of the registry;
(b) the register contacting the mobile telephone using the telephone number to transmit an activation code including a Short Message Service message, the activation code for activating the record;
(c) the owner of the user sending the activation code to the registry by the Short Message Service using the mobile telephone; and
(d) on receipt of the activation code, the registry activating the record.

### A system implementing the above method is also contemplated as being within the scope of the present invention.

Accordingly, in another aspect of the invention, there is provided a system to record the status of an item having associated therewith an unique identifying means, the item owned by an owner, the system including:
a registry to store information in a register, the information including the unique identifying means and unique owner identification means;
communication means to establish a communication link between the registry and electronic communication means that is uniquely associated with the owner;
processing means to receive the unique identification means via the communication link and to link it to the record of the item in the register;
transmission means to transmit an activation means to the electronic communication means to invite a user to reply by the transmission of the activation means back to the registry; and
activation means to activate the record on the register on receipt of the returned activation means from the electronic communication means.

The unique owner identification means may be the same as the electronic communication means. In a preferred example of the invention, the unique owner identification means is a telephone number traceable to the owner, to the exclusion of others. Preferably, the registry provides the owner with ongoing access to the records listing the owner's items in the register. The access may be by means of an access code to enable the owner to, from time to time, modify the record pertaining to the owner. For example, the owner may change name (such as by a change in company name, by a merger or as a result of marriage), move address and so on.

The owner may also have access to the item record whereby to indicate a change in status of the item. This may involve indicating that: (1) the item has been sold in a genuine sale to a new party and the record is to be removed from the register; or (2) the item has been stolen. Herein lies a useful aspect of the invention in that the registry may be used by a third party to run a check as to the status of an item with regard to registered ownership and/or whether the item is listed as stolen. For this purpose, the owner may be allocated an access code, such as a password, including an alphanumeric code, with which the owner can access its owner record and/or the item record.

Where an owner has multiple items listed in the registry, the owner may be allocated a separate access code for each item. The separate access code may be a composite of a unique owner code to which is added sequentially the numbers 1, 2, 3 and so on, or an allocated owner (customer) code combined with the unique identifying means, such as the VIN of a motorcycle.

### BRIEF DESCRIPTION OF THE SEVERAL VIEWS OF THE DRAWINGS

Preferred features of the present invention will now be described with particular reference to the accompanying drawings. However, it is to be understood that the features illustrated in and described with reference to the drawings are not to be construed as limiting on the scope of the invention. In the drawings:

FIG. 1 is a flow chart representing a registration process according to a preferred method of invention;

FIG. 2 is a flow chart representing a search procedure according to the preferred method of invention;

FIG. 3 is a screen dump of a web page presented following a search enquiry according to the preferred embodiment of present invention;

FIG. 4 is a screen dump of a web page showing alternative results of a search enquiry according to the preferred method;

FIG. 5 is a print out of an SMS message that issues during the bike registration process according to the preferred embodiment;

FIG. 6 is a screen dump of a web page presented to a user on initiating a search enquiry according to the preferred embodiment;

FIG. 7 is a print out of a text message issued to a registered owner according to the preferred embodiment; and

FIG. 8 is a flow chart representing a registration process and registry application according to another embodiment of the invention.

### DETAILED DESCRIPTION OF THE INVENTION

The registration process will be described with reference to the registration of motorcycles. However, it will be understood that the invention has wider application to a variety of valuable items susceptible unique identification. For example, the item may be a bicycle, motorcycle, white good, electronic device such as a television, VCR, CD/DVD player/recorder, computer, a piece of manufacturing, office or trade equipment, art work such as a sculpture or painting, jewelry, a rare book and so on.

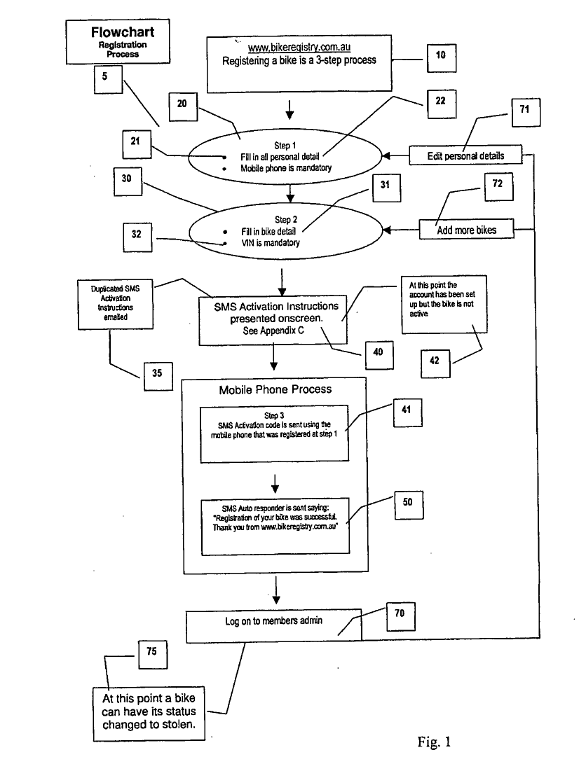

In FIG. 1 there is shown a flow chart of a registration process according to a preferred method and system for its implementation. Typically the registration process (5) is commenced by an owner of an unregistered item, such as a motorcycle, accessing a publicly available website on the internet, the present example having the website address www.bikeregistry.com.au (10). The registration process (5) is carried out by a registry organization that maintains a database or register.

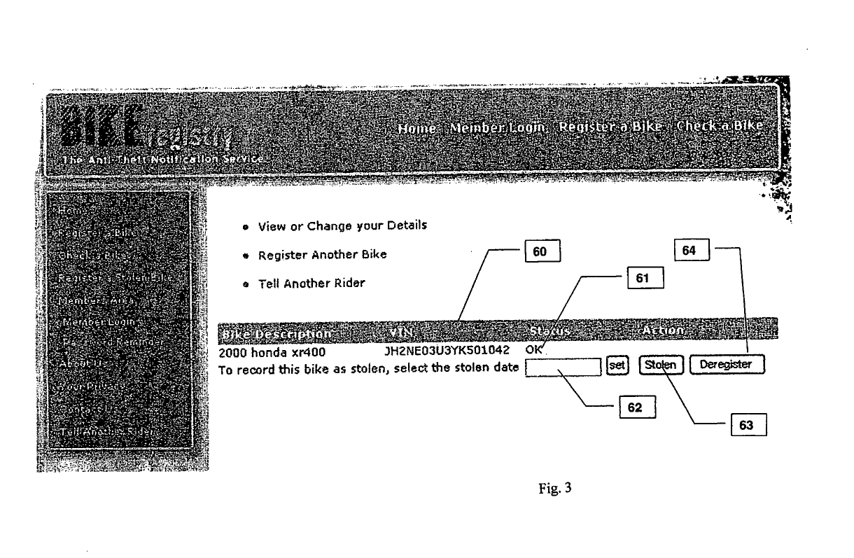

In the first step (20) of the process, the user is invited to enter the name and address details (21) of the owner. The process also requires the entry of communication details for the communication means, in this case a mobile phone number (22) of a mobile telephone owned by the owner. In step two (30), the owner is invited to fill in details (31) of the motorcycle to be registered. This may include a brief description of the make, model, color and/or year of the item. Step 2 (31) also involves the step of providing a unique identifying aspect of the item, such as an engine or chassis number, or a VIN number. In this particular example, the process requires the entry of the vehicle identification number (VIN) (32) of the motorcycle. Once the owner has confirmed the owner's and motorcycle's details, the registry creates a record in the data base for the owner's details (21)(22) and a separate record (60) (refer to FIG. 3), relationally linked, of the details (31) of the motorcycle.

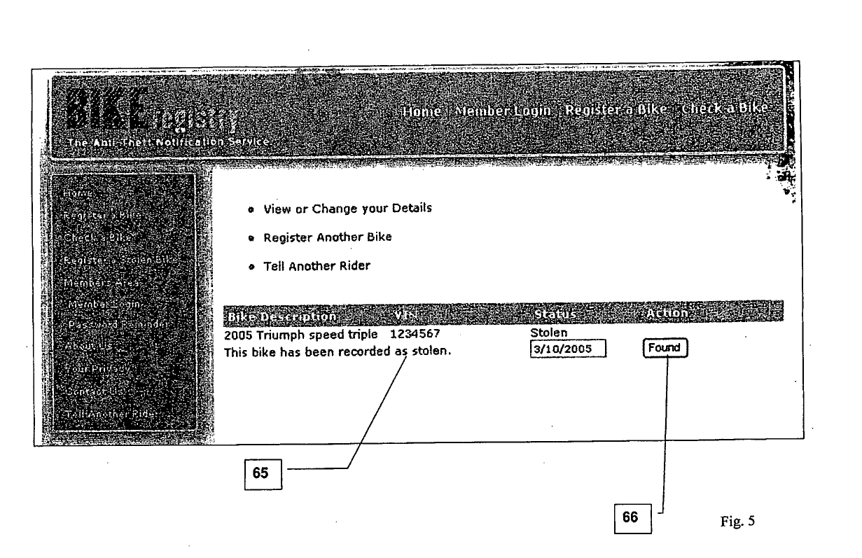

The registry system generates record activation instructions (40) which are presented on screen over the internet as shown in FIG. 5. These instructions (40) are duplicated in a short email message (35) sent to the owner's email address that was nominated in step 1 (20). With further reference to FIG. 5, the owner is provided with an activation code (36) in the form of an alphanumeric string and a telephone number (37) to which the owner is invited to send a short message service (SMS) message containing the activation code (36) in order to activate the registration of the motorcycle record on the registry.

In step 3 (41), the user sends the activation code (36) by SMS using the mobile phone that was registered in step 1 (20). It is preferable that the activation code be returned using the owner's mobile phone to provide a means of payment and a cross-check of the authenticity of the sender's identity. Therefore, in order to permit payment to be effected through the owner's telephone account, the activation code is necessarily sent by the telephone that has the unique telephone number that the registrant provided while registering on the website. This is another way of cross checking that the correct information has been provided in the registration process. Until this stage, (refer to ref. No. 42) the motorcycle record (60) is inactive, the owner's account with the registry has been set up, but the record has not been activated on the registry and a search query on the motorcycle VIN (32) entered in step 2 (30) would not yield a result to a searcher accessing the register. Accordingly, in step 3 (40) the user SMS's the activation code to the registry and this enables the registry to debit the account of the owner of the mobile phone. It is not possible to debit the owner's account if the reply SMS is sent from a different phone. The Register can only debit the account of the phone that the SMS is sent from or sent to. This step 3 avoids the known method of payment that is of dubious security, namely payment by credit card over the internet. In this respect, the registry provider must gain the permission and authority to debit a mobile telephone owner's telephone account held with the telephone service provider.

The billing process described as follows allows payment for services provided over the internet whilst avoiding the use of credit card payments, but requires the co-operation and authorization of the mobile phone service provider.

The debiting process works by prompting the user with instructions sent to them via email to send a unique code to a unique phone number from their mobile phone. The owner is required to initiate the SMS from their phone and this cancels out any complaint on their part at a later date if they query a fee on their mobile phone bill as the SMS was initiated from their phone. Once the registration process is completed the telephone service provider (telephone company) bills the owner the fee the Registry has set for the service. The Registry is then paid by the telephone service provider, for example, on a periodic (such as monthly) basis all funds that have been generated over the period. Essentially, the telephone service providers' provide a credit service for the Registry.

On receipt of the SMS (41) from the owner containing the activation code (36) sent from the owner's mobile phone, the owner's mobile phone account is debited and the motorcycle record (60) is activated and becomes fully searchable on the register by third parties wishing to make enquiries using the VIN (32) as the identification means for that particular motorcycle. By way of confirmation, the registry replies to the SMS (41) sent by the owner with an automated SMS response sent by the registry's SMS auto responder (50) confirming that the motorcycle has been activated and placed on the register.

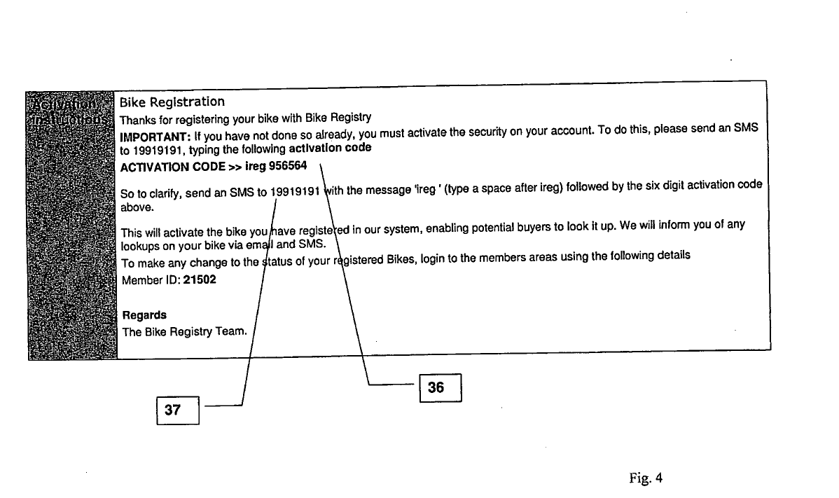

At this stage, the motorcycle record (60) shown in FIG. 3 will be listed as having a non-stolen status, i.e. “OK” (61). Thereafter, as a separate step (70), the owner may log onto the registry as a member in order to edit or modify (71) the owner's contact/ address details (21, 22) or to add further motorcycles (72) to the registry. The owner may also change the status (75) of an existing motorcycle record by changing the status of the motorcycle record to “stolen” or “deregister” (63,64). With reference to FIGS. 3 and 4, the owner may enter the date on which the motorcycle was stolen or was known to be stolen (62) and may select the stolen button (63) to change the status of the record (60) to “stolen” as shown in FIG. 4 where the record (65) is indicated as stolen on a particular date. Should the motorcycle be located and returned to the possession of the owner, the owner can select the action “found” (66) to restore the status of the motorcycle record to “OK” (61) as shown in FIG. 3. As alluded to above, the owner also has the option of removing the motorcycle record (60) from the register by selecting the “de-register” button (64) shown in FIG. 3.

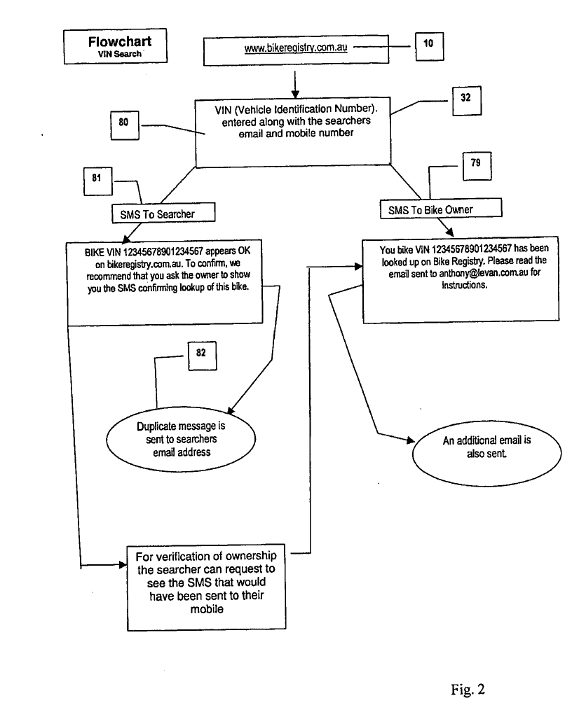

Referring now to FIGS. 2 and 5-7, the register is accessible and searchable by members of the public through the registry website (10). Activation of the motorcycle record (60) on the register enables potential buyers to search and retrieve that record (60). The owner is informed of any searches carried out on the VIN (32) via an email and an SMS message (77) sent to the owner's email address and telephone, respectively.

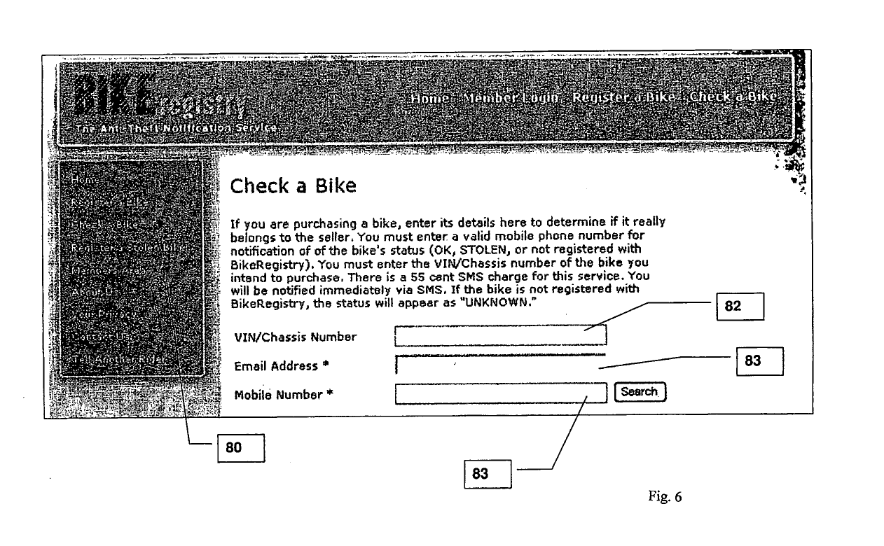

With reference to FIG. 6, the prospective purchaser may access the registry on the website (10) and may select the option “check a bike” (80) whereby a screen is displayed inviting the searcher to enter the motorcycle's VIN (32) (or chassis's number if that is the designated identification means), together with the searcher's email address (82) and mobile telephone number (83). The email transmission provides a convenient means to convey the results of the search to the searcher/enquirer and the mobile telephone number (83) provides a means to bill the enquirer without the need for credit card details. In reply, the enquirer will receive an SMS message by email and mobile phone advising of the motorcycles status, i.e. “OK”, “stolen” or “unknown”, the latter status being provided where the motorcycle is not registered with the registry.

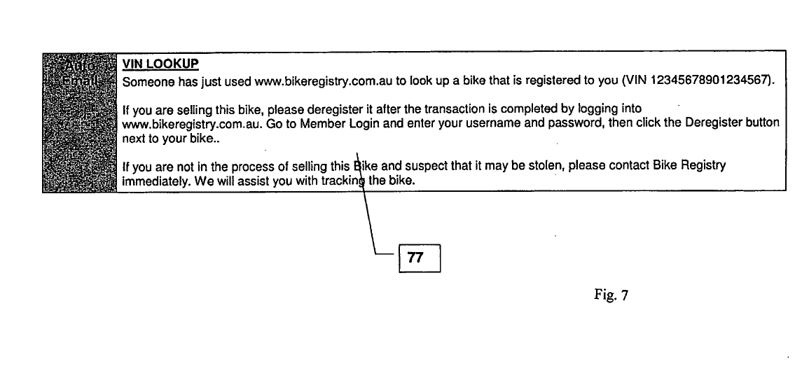

With particular reference to FIG. 7, the early alert to the owner that their motorcycle has been the subject of a search query on the registry is given in an automated email (77) sent to the owner advising that someone has made an enquiry on the register to check the VIN (32) listed on the motorcycle record. This alerts the owner to the fact that the motorcycle is on the market (irrespective of the genuineness or otherwise of the proposed sale). The SMS message (77) invites the owner to do one of two things. The owner may de-register the motorcycle entry (60) on the register should the sale be genuine and the transaction completed by going to the “member log in” (81) and entering the owner's user name and password, followed by selection of the “de-register” button (64) for the relevant motorcycle record (60). Alternatively, should the owner not be selling the motorcycle and suspect that it may be stolen, the owner is invited to contact the registry immediately to assist in tracking the bike. This may be achieved by identifying the searcher who entered his/her email and mobile phone details (refer to FIG. 6) whereby to identify the searcher and hopefully enable the person offering the motorcycle for sale to be identified and the motorcycle retrieved. The owner also has the option of indicating on the motorcycle records (60) that the motorcycle has been stolen by entering the date (62) and selecting the “stolen” button (63) shown in FIG. 3.

As shown in FIG. 2, where a searcher accesses the registry and enters in a separate searching step (80) the required details of their email, telephone number and the VIN (32) of the motorcycle, the registry sends a SMS message (81) to the searcher advising that, if applicable, the motorcycle appears to be non-stolen (“OK”) and advises the searcher to ask the person claiming to be the owner to show the SMS (77) confirming that a search request was made in respect of the motorcycle. A genuine owner will have received the SMS (79) and will normally be in a position to accede to the request. The SMS (81) sent to the searcher is duplicated in an email sent to the searcher's nominated email address (83), whereas the SMS message (79) sent to the owner is only a brief notification sent to the nominated mobile phone of the owner suggesting that the owner read the email sent to the owner's nominated email address (21) to refer to the more detailed message (77).

The following describes a system applicable to a general internet-based buying and selling service such as eBay™ auction services or The Trading Post™.

The method according to the invention can be used to implement a general internet-based buying and selling service. This would involve a prospective seller registering items (as the legitimate owner) through the buying and selling service so that in the event that any item is stolen it can be checked against this registry if someone tries to sell that item through the service. A bulletin board service would also work well. The buying and selling service could utilize a registry service method according to the invention to provide for the integrity that it would give to their brand, especially in light of bad press regarding the authenticity of products and items purported to be on sale over such services. An advantage in using the present method invention to the exclusion of others in a licensing arrangement would be to prevent other competing companies using it and watering down the advantage of them offering the registry service.

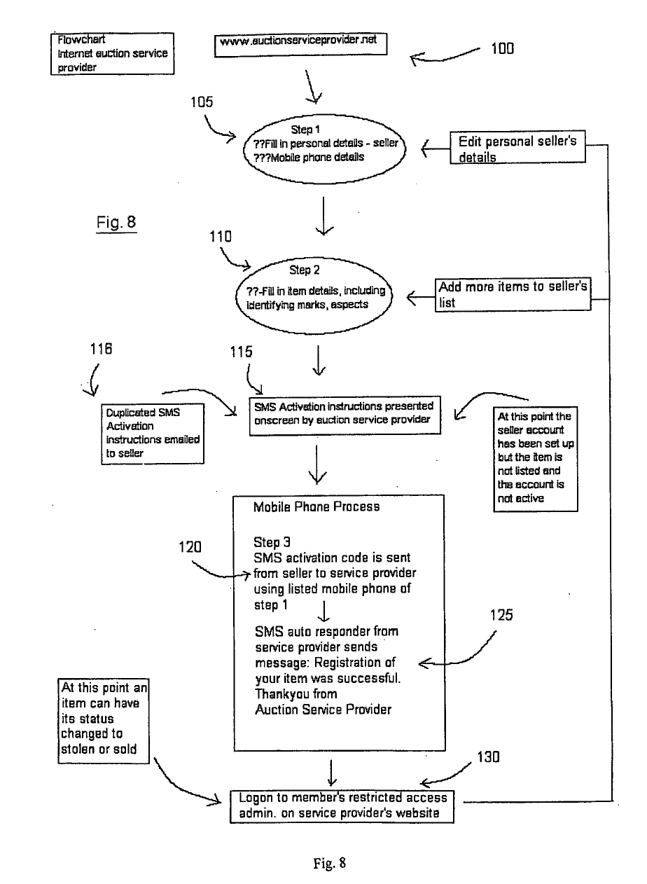

In particular, in another embodiment of the invention shown in FIG. 8, the registry service can be used by a public internet auction service (100). The seller sets up their account with the auction service provider in step 1 (105). The same mechanism in Step 2 (110) as with the bike registry shown in FIG. 1 occurs in which the seller gives similar information to the auction service provider as the owner would give to the Registry. However, if the item is to be uniquely identified, there must be some information such as a detailed description that uniquely identifies the item.

The auction service provider (100) sends an email (115) and short text message to (116) the seller providing same with details of the item to be advertised and providing an access code that the seller may include in an SMS response back to the auction service provider in Step 3 (120). The auction service provider charges the seller to place an advertisement on the auction service website. The seller acknowledges the legitimacy of the charge by returning the activation code in a message tied directly to the seller's mobile telephone (120). The auction service provider does not activate the seller's account until a successful activation code has been received from the seller's mobile telephone (125).

Once the seller's account is activated (130), the item to be auctioned/sold is listed on the auction service provider's website. A buyer may thereafter contact the seller directly and effect a purchase of the advertised goods. The seller is then expected to SMS the auction service provider and advise that the item has been sold so that the item can be delisted from the website.

The process of the present invention provides security to the payer by enabling telephone billing rather than credit card billing, and security to the buyer that the goods to be purchased come from a genuine ownership source. The identity of the seller of the goods is traceable and the seller is therefore accountable and unlikely to traffic in stolen goods through such a service (100).

A reference to the “user” includes a reference to the owner of an item unless the context requires otherwise. A reference to the owner of an item includes a reference to a person authorized to act on the owner's behalf. For example, where an owner is a company, the company may be represented by an authorized officer or employee and that person's actions may be deemed, for the purposes of this specification, to be the actions of the owner company. Where appropriate, such an authorized representative may also be referred to as a “user”. Accordingly, a reference to the “user” includes a reference to a person who accesses the registry whether as an individual owner or as a representative of the owner or otherwise on behalf of the owner.

It will be appreciated by those skilled in the art that many modifications and variations may be made to the methods of the invention described herein without departing from the spirit and scope of the invention.

What is claimed is:

1. A method for recording a status of an item by a user, said item typically not subject to statutory registration, said method comprising:
said user sending information to a registry having a register, said information comprising:
information to uniquely identify an owner of said item;
information to uniquely identify said item; and
access details of a communication means traceable to said owner and having a communication protocol compatible with said registry;
creating a record of said item on said register;
said registry sending a means to activate said record to said communication means using said access details;
said user sending the activation means to said registry using said communication means or another compatible communication means; and
on receipt of said activation means, said registry activating said record.

2. The method according to claim 1, wherein said registry is searchable by an enquirer by reference to the information to uniquely identify said item, said method further comprising:
said enquirer accessing said registry;
said enquirer enquiring on said status by inputting said item identification information; and
said registry displaying said status to said enquirer.

3. The method according to claim 1, wherein the on receipt of said activation means, said registry activating said record further comprises attributing a status to said record and said status relates to one or more of the following:
whether or not said item is recorded as stolen;
location of said item; and/or
availability of said item.

4. The method according to claim 1, wherein said registry is accessible on the internet or another suitable global information or communication network.

5. The method according to claim 1, wherein said registry is publicly available.

6. The method according to claim 1, wherein said register is a non-statutory commercial register, said method further comprising:
obtaining payment from said user, wherein said obtaining payment is a prerequisite to the on receipt of said activation means, said registry activating said record.

7. The method according to claim 2, further comprising:
obtaining payment from said enquirer, wherein said obtaining payment is prerequisite to the said registry displaying said status to said enquirer.

8. The method according to claim 6, wherein said payment from said user or a payment from an enquirer interrogating said register is obtained by debiting the telephone account of, respectively, said user or said enquirer.

9. The method according to claim 1, wherein said communication means is capable of receiving from, and/or sending text based messages to, said registry.

10. The method according to claim 1, wherein said communication means is a telephone and said access details includes a telephone number.

11. A method of paying for a required service provided by a service provider over the internet or other suitable global information or communication network to a customer, wherein the required service provider has obtained authorization from a telephone service provider to debit said telephone service provider's customers' accounts on completion of said required service whereby said telephone service provider is nominated by said required service provider as a qualified telephone service provider, said method comprising:
requiring that said customer provides to said required service provider details of a telephone number corresponding to an account held with said qualified telephone service provider, the customer's telephone capable of receiving and sending a message;
sending to said customer's telephone a message containing an activation code requesting that said customer send to said required service provider via the network a message in reply containing said activation code to provide said required service provider with the authorization to proceed to carry out said required service; and
on receiving said reply message, authorizing the execution of said required service and debiting the telephone account of said customer held with said qualified telephone service provider.

12. The method according to claim 11, wherein said required service is the provision of information from a register of items that are not subject to statutory registration.

13. The method according to claim 11, wherein said required service is the provision of information from a register of motorcycles that are not subject to statutory registration.

14. The method according to claim 11, wherein the telephone service is a mobile or cellular telephone service and said message is carried using a short message service (SMS) protocol.

15. The method according to claim 12, wherein said activation code activates a record of said item being an unregistered motorcycle whereby, prior to activation said record was unavailable to be called up as a result of a search query made on said register, but upon activation said record is available to be so searched.

16. A system according to record the status of an item having associated therewith a unique identifying means, said item owned by an owner, said system comprising:
a registry to store information in a register, said information including said unique identifying means and unique owner identification means;
communication means to establish a communication link between said registry and electronic communication means that is uniquely associated with said owner;
processing means to receive said unique identification means via said communication link and to link it to the record of said item in said register;
transmission means to transmit an activation means to said electronic communication means to invite a user to reply by the transmission of said activation means back to said registry; and
activation means to activate said record on said register on receipt of the returned activation means from said electronic communication means.

17. The system of claim 16, wherein said registry is adapted to receive information enabling the categorization or description of said item in said register.

18. A method for enabling a user to record the legal status of a motorcycle owned by an owner, said method comprising:
said user sending information to a registry having a register, said information comprising:
information to uniquely identify said motorcycle to create a record of said motorcycle on said register; and
telephone number of a mobile telephone traceable to said owner and having an Short Message Service (SMS) capability compatible with communication protocols of said registry;
said registry sending an activation code included in a SMS message to said mobile telephone using said telephone number, said activation code for activating said record to enable it to be posted on said register and available for lookup upon interrogation of said register by a third party;
said user sending said activation code to said registry by a reply SMS message using said mobile telephone or other suitable communication means; and
on receipt of said activation code, said registry activating said record.

19. A method according to claim 18, further comprising debiting the telephone account of said mobile telephone prior to or concurrent with the on receipt of said activation code, said registry activating said record.

20. A method according to claim 18, further comprising debiting the telephone account of an enquirer as a prerequisite to an interrogation of said register to establish the status of said record.
